(19) United States
(12) Patent Application Publication
(10) Pub. No.: US 2026/0014715 A1
(43) Pub. Date: Jan. 15, 2026

(54) DUAL-CUT HAND TOOL AND VISUAL INDICATOR OF CUTTING SURFACES

(71) Applicant: Snap-on Incorporated, Kenosha, WI (US)

(72) Inventor: David T. Doyle, Pleasant Prairie, WI (US)

(21) Appl. No.: 19/189,180

(22) Filed: Apr. 24, 2025

Related U.S. Application Data
(60) Provisional application No. 63/670,707, filed on Jul. 12, 2024.

(51) Int. Cl. B26B 17/00

(52) U.S. Cl. CPC B26B 17/00

(57) ABSTRACT

A hand tool having a first arm and a second arm coupled by a pivot and a handle defined away from the pivot as part of a first end of the first and second arms. The hand tool includes a nose adjacent to the pivot at a second end of the first and second arms. The nose includes a first jaw including the second end of the first arm, the first jaw including a shoulder formed to define a first cutting profile and a second cutting profile, a second jaw including the second end of the second arm, wherein the first jaw and the second jaw cooperate to define a cutting edge including the first cutting profile and the second cutting profile, and an indicator provided on the shoulder, wherein the indicator identifies the first cutting profile from the second cutting profile.

### CROSS-REFERENCE TO RELATED APPLICATION

The present application is a non-provisional patent application claiming priority to U.S. Provisional Patent Application No. 63/670,707 filed on July 12, 2024, the contents of which are hereby incorporated by reference.

### BACKGROUND

Hand tools such as cutting pliers incorporate jaws movable about a pivot and incorporating at least one cutting edge. Cutting pliers may be configured for different tasks such as wire cutting, conduit stripping, and material snipping. For example, the jaws may be manufactured to cut material and provide a finished profile. In some examples, cutting pliers may be configured to conduct multiple tasks. In these examples, a user may have to align the jaws of the cutting pliers with relative precision to ensure a particular task is conducted. The alignment of the jaws requires additional time and user effort to engage the material to be cut with the correct jaw configuration.

### SUMMARY

The disclosure relates to a dual-cut pliers or cutter configured to cuts according to two different cutting profiles. For example, a first cutting profile makes flush-cuts on ductile materials such as plastics, cable ties, and other soft material. A second cutting profile may be configured to make diagonal-cuts on a range of soft materials and hard materials.

In one embodiment, a hand tool having a first arm and a second arm coupled by a pivot is disclosed. The hand tool includes a handle defined away from the pivot, and the handle including a first end of the first arm, and a first end of the second arm; a nose defined adjacent to the pivot and including a second end of the first arm, and a second end of the second arm. The nose includes a first jaw including the second end of the first arm, the first jaw including a shoulder formed to define a first cutting profile and a second cutting profile; a second jaw including the second end of the second arm, wherein the first jaw and the second jaw cooperate to define a cutting edge including the first cutting profile and the second cutting profile; and an indicator provided on the shoulder, wherein the indicator identifies the first cutting profile from the second cutting profile.

In another embodiment, a cutting pliers including a handle formed as part of a first arm pivotably coupled to a second arm, and a cutting nose formed away from the handle by the cooperation of the first arm and the second arm is disclosed. The cutting pliers includes: a first jaw form as part of the cutting nose, the first jaw including a shoulder formed to define a first cutting profile and a second cutting profile; a second jaw form as part of the cutting nose, wherein the first jaw and the second jaw cooperate to define a cutting edge including the first cutting profile and the second cutting profile; and an indicator provided on the shoulder, wherein the indicator identifies the first cutting profile from the second cutting profile.

### BRIEF DESCRIPTION OF THE DRAWINGS

Example embodiments are described herein with reference to the drawings.

FIG. 1 shows the hand tool configured as a dual-cut pliers in accordance with an example embodiment.

FIGS. 2 to 4 show alternate views of the dual-cut pliers in accordance with an example embodiment.

FIGS. 5 and 6 show bottom perspective views of the dual-cut pliers in accordance with an example embodiment.

FIGS. 7 and 8 show sectional views of the first and second cutting profiles, and an illustrated example of the mechanical engagement provided along each portion of the cutting edge in accordance with an example embodiment.

FIGS. 9 and 10 show an indicator provided on a first surface to identify a cutting profile available on a second surface in accordance with an example embodiment.

FIGS. 11 and 12 show the first arm and second arm arranged in accordance with one or more example embodiments.

The drawings are schematic and not necessarily to scale. In the drawings, similar symbols typically identify similar components, unless context dictates otherwise.

### DETAILED DESCRIPTION

### I. INTRODUCTION

This patent document describes example embodiments for a hand tool configured as a dual-cut cutter or pliers. An example hand tool may be configured to manipulate various materials by gripping, bending, twisting, or cutting the materials or some combination of these actions. Example hand tools in accordance with one or more embodiments may include two arms joined at a fulcrum near one end and jaws for engaging a material positioned relative to the fulcrum.

An example hand tool includes a first arm and a second arm coupled by a pivot. The hand tool includes a handle defined away from the pivot, the handle including a first end of the first arm, and a first end of the second arm; a nose defined adjacent to the pivot and including a second end of the first arm, and a second end of the second arm. The nose includes a first jaw including the second end of the first arm, the first jaw including a shoulder formed to define a first cutting profile and a second cutting profile; a second jaw including the second end of the second arm, wherein the first jaw and the second jaw cooperate to define a cutting edge including the first cutting profile and the second cutting profile; and an indicator provided on the shoulder, wherein the indicator identifies the first cutting profile from the second cutting profile.

An example cutting pliers includes a handle formed as part of a first arm pivotably coupled to a second arm, and a cutting nose formed away from the handle by the cooperation of the first arm and the second arm. The cutting pliers includes: a first jaw form as part of the cutting nose, the first jaw including a shoulder formed to define a first cutting profile and a second cutting profile; a second jaw form as part of the cutting nose, wherein the first jaw and the second jaw cooperate to define a cutting edge including the first cutting profile and the second cutting profile; and at least one indicator provided on the shoulder, wherein the at least one indicator identifies the first cutting profile from the second cutting profile.

The disclosed example provides a mechanism by which different cutting profiles may be quickly selected. For example, selection between the first cutting profile and the second cutting profile may be accomplished without having to reorient the hand tool. The disclosed example provides an indicator for visually differentiating between the first cutting profile and the second cutting profile.

### II. EXAMPLE DUAL CUT PLIERS AND INDICATOR

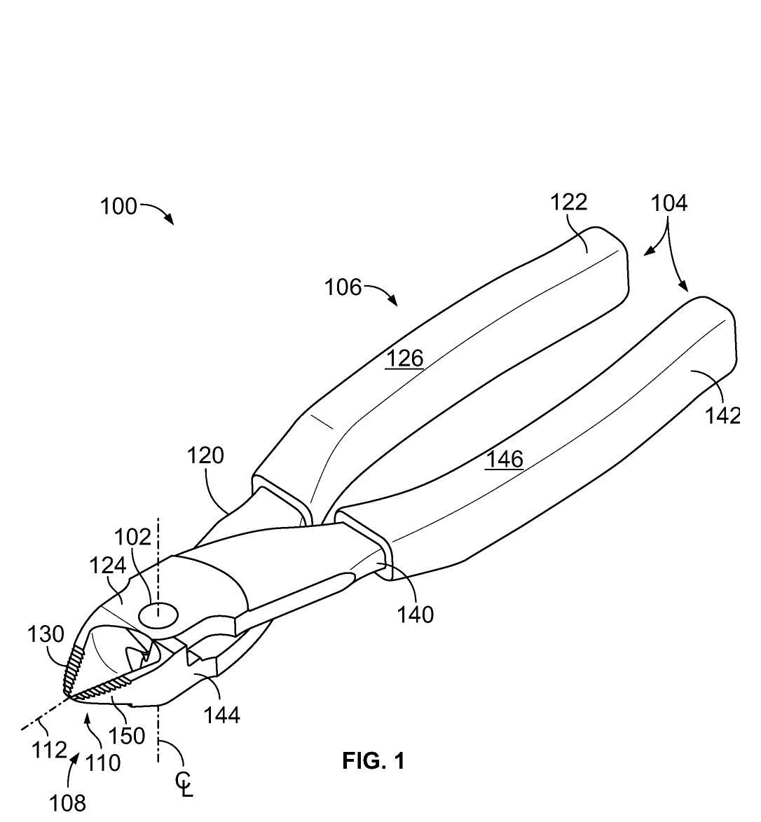

FIG. 1 shows a hand tool in accordance with an example embodiment. In particular, FIG. 1 shows the hand tool configured as a dual-cut pliers 100. The dual-cut pliers 100 includes a first arm 120 and a second arm 140 movably relative to each other around a pivot 102. The pivot 102 allows the first arm 120 to move relative to the second arm 140 about the centerline CL. The position of the pivot 102 along the lengths of the first arm 120 and the second arm 140 may be varied based on a predetermined mechanical advantage and application of the dual-cut pliers 100.

The dual-cut pliers 100 further includes a handle 104. The handle 104 comprises a first end 122 of the first arm 120, and a first end 142 of the second arm 140. The first end 122 of the first arm 120 and the first end 142 of the second arm 140 may be formed or manufactured to conform to the hand of a user. For example, the first end 122 of the first arm 120 and the first end 142 of the second arm 140 may be contoured to fit a palm and fingers of the user. The handle 104 may further incorporate a grip 106 including a first grip 126 encompassing the first end 122 of the first arm 120, and a second grip 146 encompassing the first end 142 of the second arm 140. The grip 106 may be formed from a non-slip material such as a rubber or plastic material. The grip 106 may be a removable grip the slips onto the surface of the first end 122 of the first arm 120 and the first end 142 of the second arm 140. In another example, the grip 106 may be molded or otherwise formed as part of the first end 122 of the first arm 120 and the first end 142 of the second arm 140.

The dual-cut pliers 100 further includes a nose 108 formed substantially adjacent to the pivot 102 and away from the handle 104. The nose 108 includes jaws 110 movable relative to the pivot 102. The jaws 110 include a first jaw 130 formed at a second end 124 of the first arm 120, and a second jaw 150 formed at a second end 144 of the second arm 140. When in a closed position, the alignment of the first jaw 130 and the second jaw 150 of the jaws 110 define a cutting edge 112.

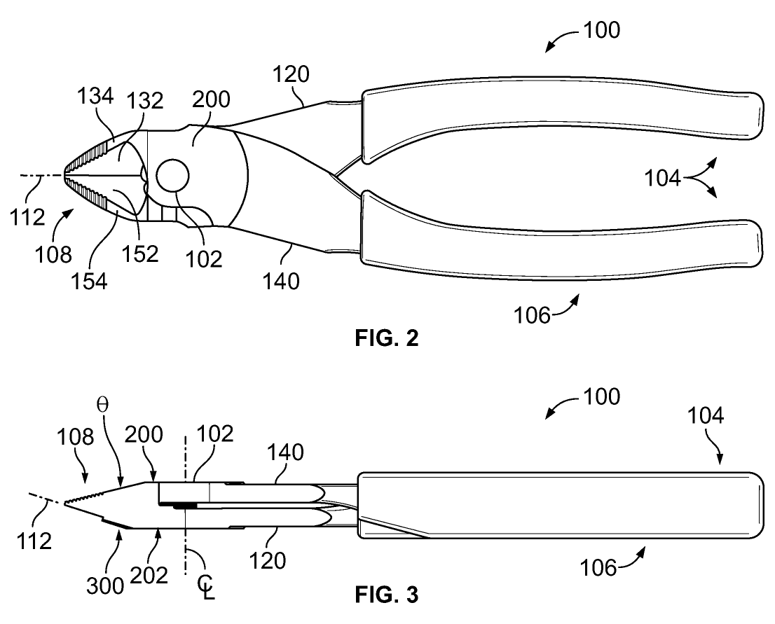

FIGS. 2 to 4 show alternate view of the dual-cut pliers 100 in accordance with an example embodiment. FIG. 2 shows a top plan view of the dual-cut pliers 100 including a top or first surface 200 formed as part of the second arm 140. The nose 108 of the dual-cut pliers 100 includes a cutting surface 132 and a cutting surface 152. For example, the cutting surface 132 extends between a shoulder 134 and the cutting edge 112. Similarly, the cutting surface 152 extends between a shoulder 154 and the cutting edge 112.

FIG. 3 shows a side view of the dual-cut pliers 100 including a bottom (or second) surface 202 formed as part of the second arm 120. The bottom surface 202 is defined opposite the top or first surface 200 formed as part of the second arm 140. FIG. 3 further shows that the nose 108 is a pointed or tapered structure formed with an angle θ. In other example embodiments, the length of the pointed nose and the angle θ may be tailored to the specific task(s) the hand tool is to address.

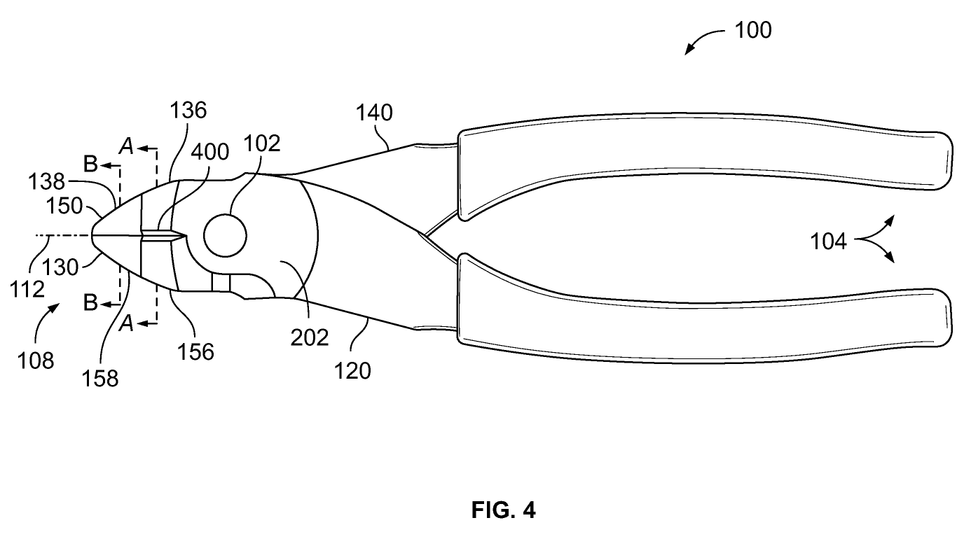

FIG. 4 shows a bottom view of the dual-cut pliers 100 including the bottom or second surface 202 formed as part of the second arm 120. FIG. 4 shows the nose 108 and the jaws 110 incorporate two cutting profiles aligned along the cutting edge 112. For example, the first jaw 130 includes a first cutting profile 136 and a second cutting profile 138, while the second jaw 150 includes a first cutting profile 156 and a second cutting profile 158 arranged complimentary to the first jaw 130. As shown in FIG. 3, the first cutting profile includes additional thickness forming a step 300 on the bottom surface 202. As shown in FIG. 4, the step 300 further includes a relief 400 formed along and aligned with the cutting edge 112.

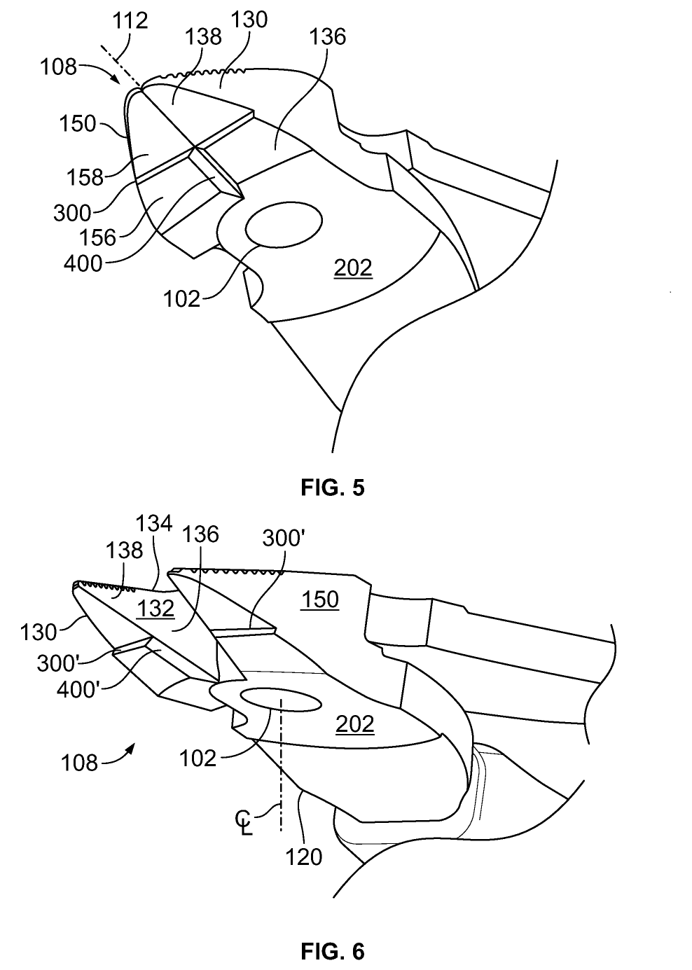

FIGS. 5 and 6 show bottom perspective view of the dual-cut pliers 100. FIG. 5 shows a bottom perspective view of the dual-cut pliers 100 with the jaws 110 in a closed position. FIG. 6 shows a bottom perspective view of the dual-cut pliers 100 with the jaws 110 in an open position.

FIG. 5 shows the jaws 110 in a closed position such that the first jaw 130 and the second jaw 150 are aligned relative to each other to define the cutting edge 112. The jaws 110 further illustrate the relief 400 provided a part of the step 300 on the bottom surface 202. For example, as shown in FIG. 6, the relief 400 is defined by a chamfer aligned to establish at least a portion of the cutting edge 112 corresponding to the first cutting profile 136 and the first cutting profile 156. The cutting edge 112 corresponding to the second cutting profile 138 and the second cutting profile 158 may, in some examples, provide for a straight cut without a substantial chamfer provided along the corresponding cutting edge 112. FIG. 6 further shows the cutting surface 132 extending between the shoulder 134 to define the first cutting profile 136 and the second cutting profile 138.

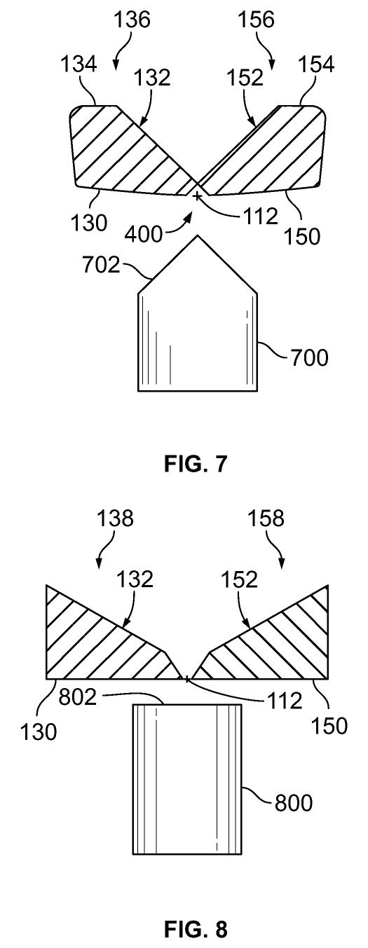

FIGS. 7 and 8 show sectional views of the first and second cutting profiles, and an illustrated example of the mechanical engagement provided along each portion of the cutting edge 112 when the jaws 110 engage a workpiece. FIG. 7 shows a sectional view of the first cutting profile 136 and the first cutting profile 156 taken along the section line A-A shown in FIG. 4. For example, the cutting surface 132 and the cutting surface 152 cooperate to define the relief 400 when the jaw 130 and the jaw 150 are aligned to define the cutting edge 112. In operation, when a workpiece 700 is mechanically engaged by the jaws 110 as they move from the open position shown in FIG. 6 to the closed position shown in FIG. 5, a pointed or tapered cut 702 is formed.

FIG. 8 shows a sectional view of the second cutting profile 138 and the second cutting profile 158 taken along the section line B-B shown in FIG. 4. For example, the cutting surface 132 and the cutting surface 152 cooperate when the jaw 130 and the jaw 150 are aligned to define the cutting edge 112. In operation, when a workpiece 800 is mechanically engaged by the jaws 110 as they move from the open position shown in FIG. 6 to the closed position shown in FIG. 5, a flat or clean cut 802 is formed.

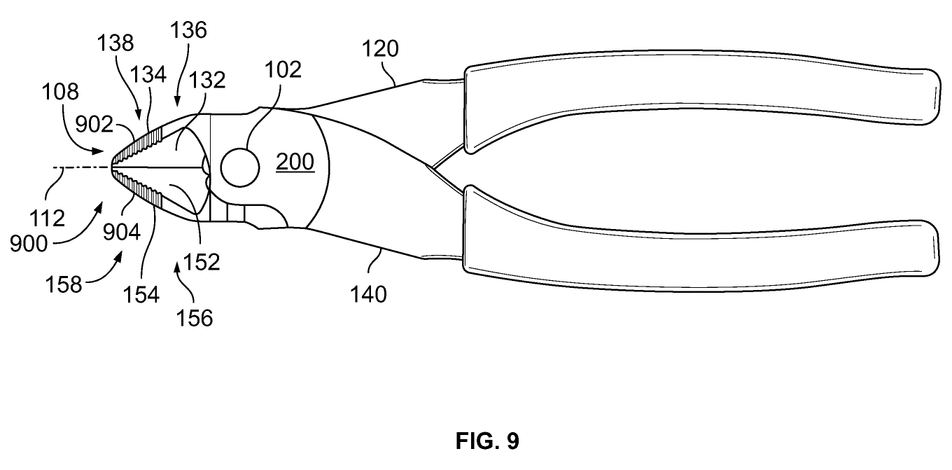

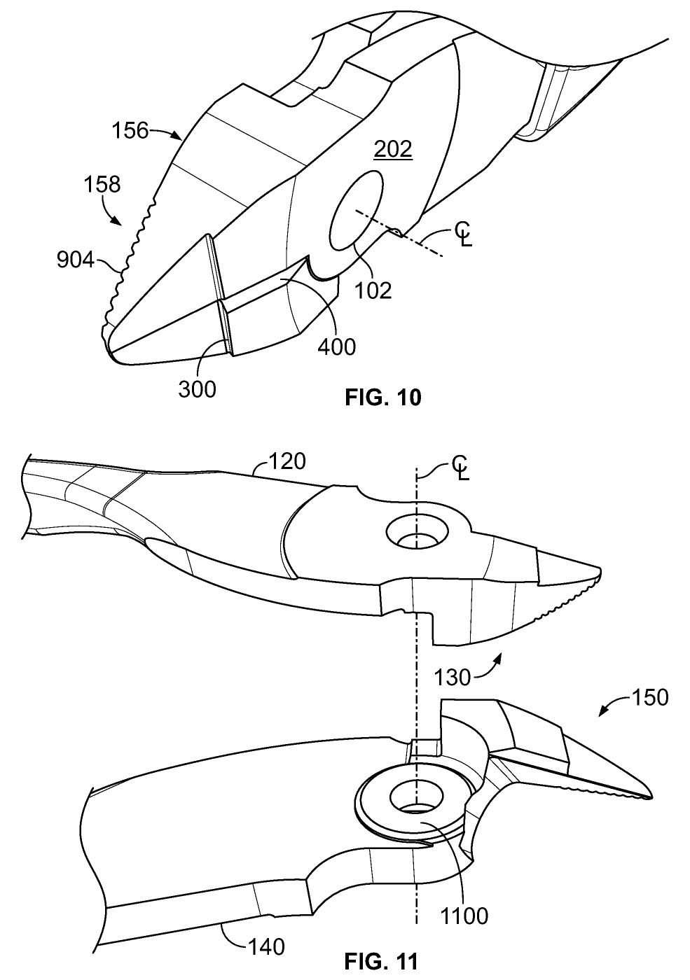

FIGS. 9 and 10 show an indicator provided on a first surface to identify a cutting profile available on a second surface. FIG. 9 shows a top view of the nose 108 incorporating an indicator 900 formed on the first or upper surface 200 of the dual-cut pliers 100. The indicator 900 may be provided as part of the shoulder 134 of the first jaw 130 and the shoulder 154 of the second jaw 150. As shown in FIG. 9, the indicator 900 may include a machined indicator 902 formed as part of the shoulder 134, and an indicator 904 formed as part of the shoulder 154. The indicator 900 may be grooves, knurling, surface treatment and/or another pattern machined or formed as part of the first or upper surface 200 of the jaws 110. In this way, the indicator 902 and the indicator 904 may be a machined indicator integral to the dual-cut pliers 100. The indicator 902 is thus durable and can be formed as part of the overall process of manufacturing the first and second arms 120, 140. The process of making the indicator 902 is finished when the machining process is completed.

In some example embodiments, the indicator 900 may be a step, similar to the step 300, formed as part of the shoulder 134 and the shoulder 154. In this example, the step may include material and thickness on the first surface 200 that identifies the position of the first cutting profile relative to the second cutting profile. Similarly, the additional material and thickness may be configured to include a pattern such as knurling. In another example, the additional material and thickness may be configured to perform an additional task, provide another cutting edge, or any other working surface.

The indicator 900 including the indicator 902 is aligned to identify the second cutting profile 138 and the transition to the first cutting profile 136. Similarly, the indicator 900 including the indicator 904 is aligned to identify the second cutting profile 158 and the transition to the first cutting profile 156. FIG. 10 shows the step 300 formed on the second or bottom surface 202 aligned with the indicator 904 formed on the first or top surface 200. The resulting indicator 902 is even more durable and can be even easier for a user of the dual-cut pliers 100 to discern. As before, the process of making the indicator 902 is finished when the machining process is completed.

Conversely, the indicator 900 may include a color indicator, such as paint applied the handle 120, 140. The color indicator may be applied to the machined or step indicators discussed above. The addition of a color indicator makes the indicator 900 even easier for the user to discern, particularly in low-light conditions. In an alternative, example embodiment, the color indicator is simply applied to the handles 120, 140 without any machining or the creating of steps on the handles 120, 140. Such an approach for applying the indicator 900 to the handles 120, 140 does not require the potentially more time-consuming process of machining. In some embodiments, the color indicator may be orange or white.

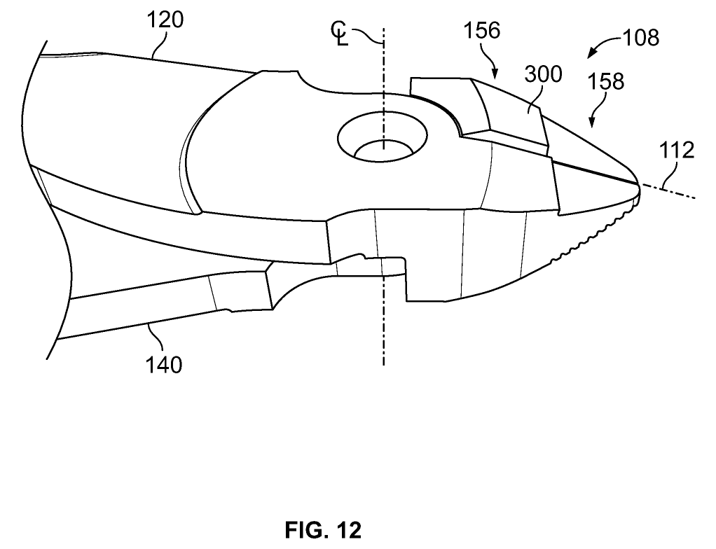

FIGS. 11 and 12 show the first arm 120 and second arm 140 in accordance with an example embodiment. FIG. 11 shows the first arm 120 and the second arm 140, respectively, aligned prior to assembly along the centerline CL. For example, the second arm 140 includes a bearing surface 1100 formed adjacent to the second jaw 150. The aligned first arm 120 may incorporate a complimentary bearing surface adjacent to the first jaw 130. In operation, the two bearing surfaces may slide rotationally relative to each other as the first arm 120 and the second arm 140 are moved about the pivot 102 and centerline CL.

FIG. 12 shows the first arm 120 and the second arm 140 aligned along the centerline CL and assembled such that the bearing surface 1100 works against the complimentary bearing surface. The limited contacted between the two bearing surfaces reduces the friction between the first arm 120 and the second arm 140.

### III. CONCLUSION

It should be understood that the arrangements described herein and/or shown in the drawings are for purposes of example only and are not intended to be limiting. As such, those skilled in the art will appreciate that other arrangements and elements (e.g., machines, interfaces, functions, orders, and/or groupings of functions) can be used instead, and some elements can be omitted altogether.

While various aspects and embodiments are described herein, other aspects and embodiments will be apparent to those skilled in the art. The various aspects and embodiments disclosed herein are for purposes of illustration and are not intended to be limiting, with the true scope being indicated by the claims, along with the full scope of equivalents to which such claims are entitled. It is also to be understood that the terminology used herein for the purpose of describing embodiments only, and is not intended to be limiting.

In this description, the articles “a,” “an,” and “the” are used to introduce elements and/or functions of the example embodiments. The intent of using those articles is that there is one or more of the introduced elements and/or functions.

Implementations of the present disclosure can thus relate to one of the enumerated examples (EE) listed below.

EE 1 is a hand tool having a first arm and a second arm coupled by a pivot is disclosed. The hand tool includes a handle defined away from the pivot, the pivot including a first end of the first arm, and a first end of the second arm; a nose defined adjacent to the pivot, the nose including a second end of the first arm, and a second end of the second arm. The nose includes a first jaw including the second end of the first arm, the first jaw including a shoulder formed to define a first cutting profile and a second cutting profile; a second jaw including the second end of the second arm, wherein the first jaw and the second jaw cooperate to define a cutting edge including the first cutting profile and the second cutting profile; and an indicator provided on the shoulder, wherein the indicator identifies the first cutting profile from the second cutting profile.

EE 2 is the hand tool of EE 1, the shoulder is defined on a first surface of the nose.

EE 3 is the hand tool of EE 1 or EE 2, the cutting edge is defined on a second surface of the nose opposite to the first surface.

EE 4 is the hand tool of EE 1 to EE 3, the handle includes a grip covering the first end of the first arm, and the first end of the second arm.

EE 5 is the hand tool of EE 1 to EE 4, the hand tool further includes a first bearing surface formed on the first arm adjacent to the pivot; and a second bearing surface formed on the second arm adjacent to the pivot.

EE 6 is the hand tool of EE 5, the first bearing surface is formed as part of the first jaw, and the second bearing surface is formed as part of the second jaw.

EE 7 is the hand tool of EE 1 to EE 6, the indicator is a machined indicator.

EE 8 is the hand tool of EE 7, the machined indicator is one of: grooves, knurling, and surface treatment.

EE 9 is the hand tool of EE 1 to EE 6, the indicator is a color indicator.

EE 10 is a cutting pliers including a handle formed as part of a first arm pivotably coupled to a second arm, and a cutting nose formed away from the handle by the cooperation of the first arm and the second arm is disclosed. The cutting pliers includes: a first jaw form as part of the cutting nose, the first jaw including a shoulder formed to define a first cutting profile and a second cutting profile; a second jaw form as part of the cutting nose, wherein the first jaw and the second jaw cooperate to define a cutting edge including the first cutting profile and the second cutting profile; and at least one indicator provided on the shoulder, wherein the at least one indicator identifies the first cutting profile from the second cutting profile.

EE11 is the cutting pliers of EE10, the shoulder is defined on an upper surface of the nose.

EE12 is the cutting pliers of EE10 or EE11, the cutting edge is defined on a second surface of the nose opposite to the first surface.

EE13 is the cutting pliers of EE10 to EE12, the handle includes a grip covering a first end of the first arm, and a first end of the second arm.

EE14 is the cutting pliers of EE10 to EE13: a first bearing surface formed adjacent to first jaw and the pivot; and a second bearing surface formed adjacent to second jaw and the pivot.

EE15 is the cutting pliers of EE14, the first bearing surface is formed as part of the first arm, and the second bearing surface is formed as part the second arm.

EE16 is the cutting pliers of EE10 to EE15, the at least one indicator is a machined indicator.

EE17 is the cutting pliers of EE16, the machined indicator is one of: grooves, knurling, and surface treatment.

EE18 is the cutting pliers EE10 to EE15, the indicator is a color indicator.

The use of ordinal numbers such as “first,” “second,” “third” and so on is to distinguish respective elements rather than to denote an order of those elements unless the context of using those terms explicitly indicates otherwise. Further, the description of a “first” element, such as a first plate, does not necessitate the presence of a second or any other element, such as a second plate.

What is claimed is:

1. A hand tool having a first arm and a second arm coupled by a pivot, the hand tool comprising:
a handle defined away from the pivot, the handle including a first end of the first arm, and a first end of the second arm;
a nose defined adjacent to the pivot, the nose including a second end of the first arm, and a second end of the second arm, the nose comprises:
a first jaw including the second end of the first arm, the first jaw including a shoulder formed to define a first cutting profile and a second cutting profile;
a second jaw including the second end of the second arm, wherein the first jaw and the second jaw cooperate to define a cutting edge including the first cutting profile and the second cutting profile; and
an indicator provided on the shoulder, wherein the indicator identifies the first cutting profile from the second cutting profile.

2. The hand tool of claim 1, wherein the shoulder is defined on a first surface of the nose.

3. The hand tool of claim 2, wherein the cutting edge is defined on a second surface of the nose opposite to the first surface.

4. The hand tool of claim 1, wherein the handle includes a grip covering the first end of the first arm, and the first end of the second arm.

5. The hand tool of claim 1, further comprising:
a first bearing surface formed on the first arm adjacent to the pivot; and
a second bearing surface formed on the second arm adjacent to the pivot.

6. The hand tool of claim 6, wherein the first bearing surface is formed as part of the first jaw, and the second bearing surface is formed as part of the second jaw.

7. The hand tool of claim 1, wherein the indicator is a machined indicator.

8. The hand tool of claim 1, wherein the machined indicator is one of: grooves, knurling, and surface treatment.

9. The hand tool of claim 1, wherein the indicator is a color indicator.

10. A cutting pliers including a handle formed as part of a first arm pivotably coupled to a second arm, and a cutting nose formed away from the handle by the cooperation of the first arm and the second arm, the cutting pliers comprising:
a first jaw form as part of the cutting nose, the first jaw including a shoulder formed to define a first cutting profile and a second cutting profile;
a second jaw form as part of the cutting nose, wherein the first jaw and the second jaw cooperate to define a cutting edge including the first cutting profile and the second cutting profile; and
an indicator provided on the shoulder, wherein the at least one indicator identifies the first cutting profile from the second cutting profile.

11. The cutting pliers of claim 10, wherein the shoulder is defined on an upper surface of the nose.

12. The cutting pliers of claim 11, wherein the cutting edge is defined on a second surface of the nose opposite to the first surface.

13. The cutting pliers of claim 10, wherein the handle includes a grip covering a first end of the first arm, and a first end of the second arm.

14. The cutting pliers of claim 10, further comprising:
a first bearing surface formed adjacent to first jaw and the pivot; and
a second bearing surface formed adjacent to second jaw and the pivot.

15. The cutting pliers of claim 14, wherein the first bearing surface is formed as part of the first arm, and the second bearing surface is formed as part the second arm.

16. The cutting pliers of claim 10, wherein the at least one indicator is a machined indicator.

17. The cutting pliers of claim 16, wherein the machined indicator is one of: grooves, knurling, and surface treatment.

18. The cutting pliers of claim 10, wherein the at least one indicator is a color indicator.
